(19) United States
(12) Patent Application Publication
(10) Pub. No.: US 2004/0263609 A1
(43) Pub. Date: Dec. 30, 2004

(54) Wireless camera network system and wireless image capturing device

(76) Inventors: Kazuhiro Otsuki, Tokyo (JP); Ken Nishiwaki, Tokyo (JP); Hideyuki Sasaki, Tokyo (JP)

Correspondence Address: HARNESS, DICKEY & PIERCE, P.L.C., P.O. BOX 828, BLOOMFIELD HILLS, MI, 48303, US

(21) Appl. No.: 10/829,972

(22) Filed: Apr. 22, 2004

(30) Foreign Application Priority Data
Jun. 30, 2003 (JP) 2003-188025

(51) Int. Cl. H04B 1/38

(52) U.S. Cl. 348/14.02

(57) ABSTRACT

Wireless camera network system and a wireless image capture device that can carry out stable image monitoring over a long time interval even outdoors. In a wireless image capturing device, power is input from a plurality of external power devices that supply drive power for an image capturing unit and a transmitter-receiver unit from a plurality of power input units, the image capturing unit captures images, the transmitter-receiver unit transmits the images via a wireless telecommunication network, and the server connected via the wireless image capturing device and the wireless telecommunication network receive the images.

### CROSS-REFERENCE TO RELATED APPLICATIONS

Priority is claimed on Japanese Patent Application No. 2003-188025, filed Jun. 30, 2003, the content of which is incorporated herein by reference.

### BACKGROUND OF THE INVENTION

1. Field of the invention

The present invention relates to a wireless IP camera network system for integrated management of real time images of a remote location, and in particular, relates to a technology that enables use of images and video of a remote location via a wireless network by using a wireless image capturing apparatus.

2. Description of Related Art

Conventionally, the management and administrative costs of managed facilities that are located in a small area can be reduced by lowering the cost of managing the buildings. For example, instead of being permanently stationed at a building, a building manager can be dispatched to a plurality of buildings while being supervised from a central location. The monitoring supervisors and the building operators implement this remote management by having the monitoring supervisors carry out the management and administration based on images taken by CCD cameras in the buildings via a network (refer, for example, to Japanese Unexamined Patent Application, First Publication No. 2002-133559).

In contrast, when the managed facilities are situated at a plurality of locations over a wide area, facility management is carried out by using a database that records drawing information of the facility record pictures and the like and a character base.

The camera network system described above generally uses a fixed-line LAN or a network such as the Internet, and it is assumed that the system will be used indoors. However, there are many cases in which building a camera network system only in order to handle short-term image monitoring presents cost problems.

In addition, there is the problem a fixed camera network system cannot be used to handle image monitoring rapidly during sudden and unexpected events (for example, natural disasters) that occur outdoors.

In contrast, while the communication of image information has been made possible by the increasingly high functionality of mobile terminals such as a mobile telephone terminal or a PDA terminal, there is the problem that the processing capacity and continuous usable time of these terminals cannot satisfy the needs described above.

### SUMMARY OF THE INVENTION

In consideration of the problems described above, it is an object of the present invention to provide a wireless camera network system and a wireless image capturing device that make possible carrying out stable image monitoring over a long time interval outdoors.

In order to solve the problems described above, one aspect of the invention is directed to a wireless camera network system. The system includes: at least one wireless image capturing device having an image capturing device that captures images, a transmission device that transmits the images captured by the image capturing device via a wireless telecommunication network, and a plurality of power input devices that receive power from a plurality of external power devices for the image capturing device and the transmission device; and a server connected to the wireless image capturing device via the wireless telecommunication network, for receiving images transmitted by the wireless image capturing device.

Preferably, the server associates the received images with the wireless image capturing device to write into a predetermined memory device.

Advantageously, the wireless image capturing device has a location information acquisition device that acquires location information having latitude and longitude information for an imaged location by communicating with a GPS satellite; the transmission device transmits the location information acquired by the image information acquisition device via the wireless telecommunication network; and the server receives the location information from the wireless image capturing device, associates the received image with the received location information to write into a predetermined memory device.

Advantageously, the memory device stores facility information associated with at least one predetermined wireless image capturing device or with predetermined location information; and the server associates the received image with at least one wireless image capturing device or the location information, and further associates the facility information to write into the memory device.

Another aspect of the invention is related to a wireless image capturing device. The device includes: an image capturing device for capturing images; a transmission device for transmitting images captured by the image capturing device via a wireless telecommunication network; and a plurality of power input devices inputting power from a plurality of external power devices that supply the power for the image capturing device and the transmission device.

Preferably, the plurality of power input devices comprise power interfaces for different input voltages, respectively.

Advantageously, the plurality of power input devices comprise power interfaces for different input voltages and power interfaces for a plurality of identical input voltages.

### BRIEF DESCRIPTION OF THE DRAWINGS

FIG. 1 is a structural drawing of the system of the present embodiment.

FIG. 2 is a structural drawing of the wireless image capturing device.

FIG. 3 is a flowchart related to the image capturing processing.

### DETAILED DESCRIPTION OF THE INVENTION

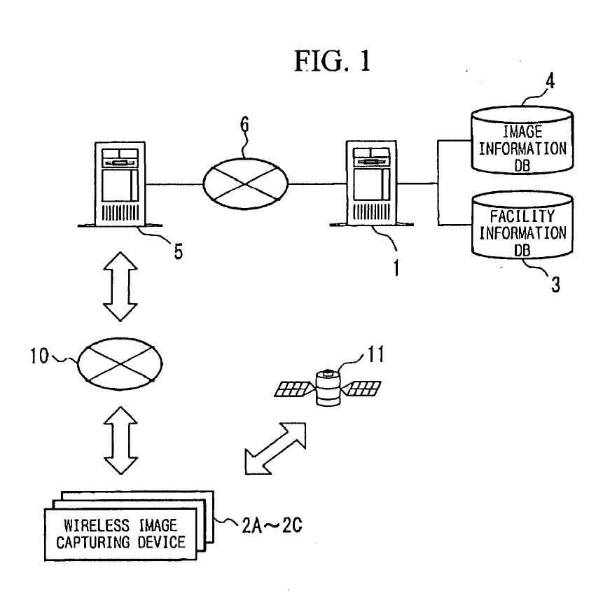

Below, an embodiment of the wireless camera network system of the present invention will be explained with reference to the drawings. FIG. 1 is a structural drawing showing the configuration of the wireless camera network system of the present embodiment. The wireless camera network system of the present embodiment is formed by connecting a server 1 on a LAN or a fixed-line network 6 such as the Internet and a plurality of wireless image capturing device terminals 2A to 2C via a mobile telecommunication network 10 (for example, a wireless telecommunication network such as the FOMA (Registered Trademark) network).

The server 1 is disposed, for example, at a natural disaster response center, is connected to a memory unit formed by a facility information management database 3 (below, database is denoted by DB) and an image information DB 4, and manages the images captured by the wireless image capturing devices 2A to 2C via an access server 5 that serves as a gateway between the fixed-line network 6 and the mobile telecommunication network 10.

Concretely, the server 1 is formed by a control unit, an input/output unit, and a transmitter-receiver unit.

The control unit controls the data input/output in the input/output unit, the transmitter-receiver unit, and the memory unit.

The transmitter-receiver unit receives identification information and location information of the wireless image capturing devices 2A to 2C and the images captured by the wireless image capturing devices 2A to 2C, associates the respective identification information and the location information, then associates the result with the facility information stored in the facility information management DB3, and finally writes the results into the image information DB 4 (explained below).

The facility information management DB3 stores the facility information associated with predetermined location information, Here, facility information is information related to facilities that are managed by the user, and includes for example, location information such as the control number of the facility and the longitude and latitude information, an index that shows the association with the bitmap formatted or vector formatted map information, ownership class of the ownership of the facility, and names associated with other facilities defined on the map.

Note that in the present specification, the map information consists of maps, aerial panorama images and the like that are associated with the location information for each of the facilities.

The image information DB 4 stores image information received from the wireless image capturing device terminals 2A to 2C.

The wireless image capturing terminals 2A to 2C are mobile devices having built-in 1P cameras for carrying out the image monitoring outdoors over a long time period, and provide a communication interface with the FOMA network 10.

Concretely, the wireless image capturing terminals 2A to 2C are formed by a control unit, an image capturing device, a position information acquisition unit, a transmitter-receiver unit, and a plurality of power input units.

The control unit carries out data input/output control in the image capturing unit, the location information acquisition unit, and the transmitter-receiver unit, and also carries out control of the power input from the plurality of power input and output units.

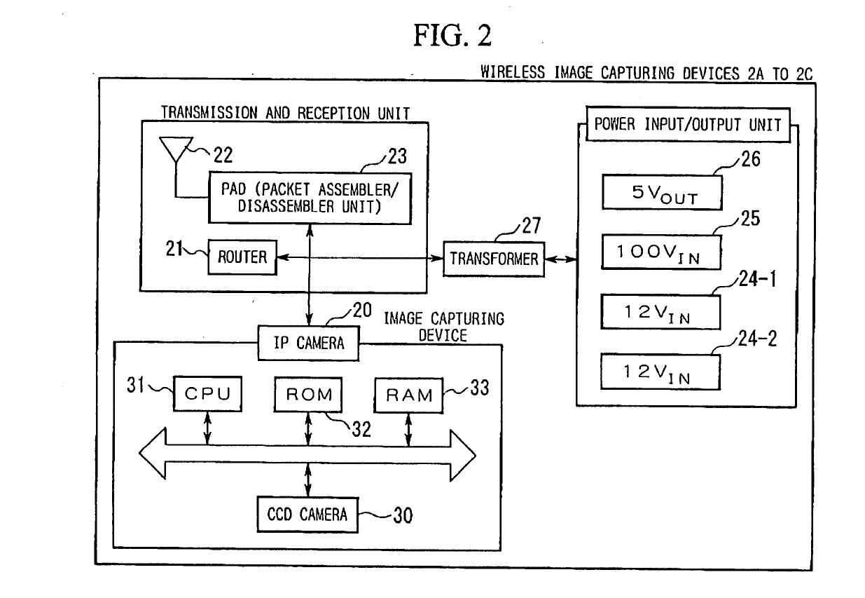

As shown in FIG. 2, the image capturing unit is an IF camera 20 formed by connecting a CCD camera 30, a CPU 31, ROM 32, and RAM 33 using a bus, and takes images in a photographic field determined by the remote control from the server 1 or another control terminal (not illustrated).

The location information acquisition unit is formed by a GPS terminal (or a FDA having a GPS antenna) connected via the router 21 shown in FIG. 2, and acquires the location information that includes the longitude and latitude information for the photographed locations by communication with a GPS satellite (refer to FIG. 1).

The transmitter-receiver unit is formed by a router 217 an antenna 22, and a PAD (packet assembler/disassembler) 23 for transmitting images taken by the image capturing unit and location information acquired by the location information acquisition unit. The router 21 routes the image information taken by the IP camera 20 to the server 1 via the PAD 23. The PAD 23 disassembles the image information input by the router 21 into packet data, and outputs this to the antenna 22. The antenna 22 transmits the input data packet to the server I via the mobile telecommunication network 10.

The plurality of power input/output units input power from a plurality of external power devices that supply drive power for the image capturing unit and the transmitter-receiver unit. The plurality of power input units have a power source interface having different input voltages, and are formed by one or a plurality of power source interfaces each having different input/output voltages and a plurality of power source interfaces having identical input/output voltages.

As shown in FIG. 2, in the present embodiment, the plurality of power input units provide two 12 V (volt) power input interfaces (in FIG. 2, 12V_{IN} 24-1, 2), a 100V power input interface (100 V_{IN}25), and a 5V power source output interface (5V_{OUT}26).

Note that, as shown in FIG. 2, depending on the installation, transformers 27 for transforming the input voltage to a drive voltage for the IP camera 20, the router 21, and the PAD 23 can be provided between each of the devices and the power input/output units.

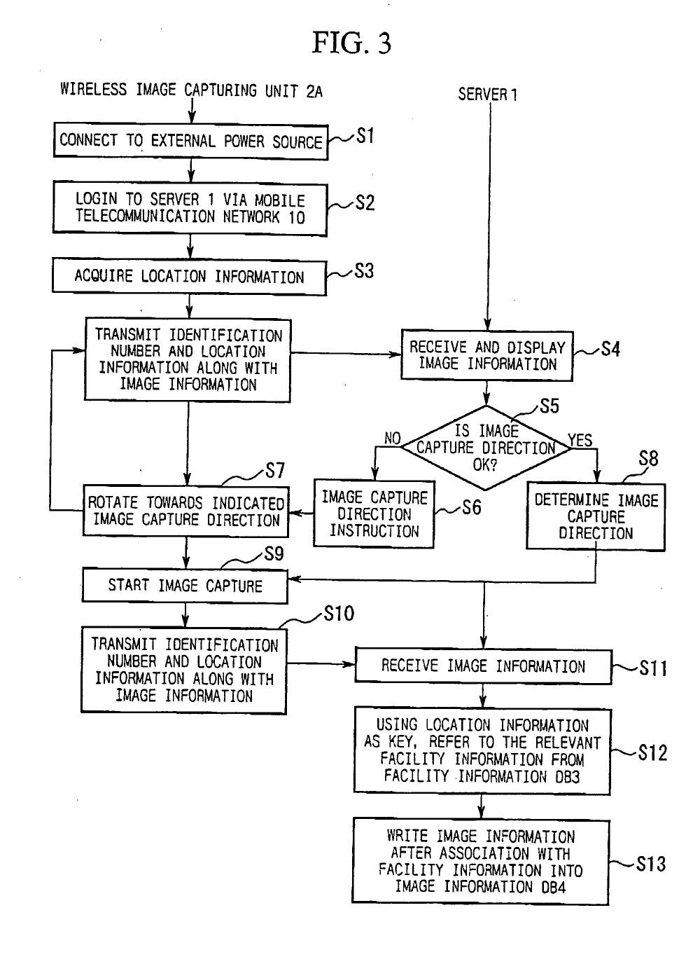

Next, the operation of the wireless camera network system of the present embodiment will be explained with reference to the figures. FIG. 3 is a flowchart showing the processes of the database control and image capture/data communication processing of the image information by the wireless camera network system of the present embodiment.

When image capturing of a location becomes necessary due to a natural disaster or the like, the wireless image capturing devices 2A to 2C are disposed at the site where the natural disaster has occurred (below, the wireless image capturing device 2A will be explained as a representative example).

In the case that a household 100V power source facility near the location where the natural disaster has occurred is not available and electricity cannot be delivered, the user supplies drive power for the wireless image capturing device 2A from an external power device such as a 12V battery mounted in a vehicle (FIG. 3, step S1). Note that it is also possible similarly to supply drive power from 5V_{OUT} to a PDA terminal, GPS terminal or the like externally connected to the wireless image capturing device 2A via the router 21.

When the wireless image capturing device 2A has been activated, the IP camera 20 reads out the IP address of the server 1 that has been registered in advance, and transmits an access request to the server 1 via the mobile telecommunication network 10. The server 1 transmits an authentication request to the IP camera 20 in response to this access request.

Having received the authentication request, the IP camera 20 reads out the identification number and password of the wireless image capturing device 2A, which has been preset, and transmits this to the server 1. Note that instead of storing this password in the wireless image capturing device 2A in advance, it is also possible, for example, for the user to input the password by using a PDA terminal connected via the router 21.

When the server 1 receives the identification number and password for the wireless image capturing device 2A, the server 1 finds whether or not the identification number of the wireless image capturing device 2A has been registered by an authentication management DB (not illustrated) for wireless image capturing devices in the server 1, and password authentication is carried out by verifying the password.

In the case that the received password of the wireless image capturing device 2A agrees with the password registered in the authentication management DB, the server 1 is notified that the wireless image capturing device 2A has been authenticated. By the processing described above, the wireless image capturing device 2A logs into the server 1 (step S2).

After the log-in has completed, the wireless image capturing device 2A outputs the location information acquisition request to the GPS terminal connected via the router 21. The GPS terminal calculates the location information (for example, latitude and longitude information) of the wireless image capturing device 2A by communicating with the GPS satellite 11 based on this location information acquisition request, and outputs the result to the wireless image capturing device 2A (step S3).

Next, the wireless image capturing device 2A outputs the image capture start request to the IP camera 20.

The IP camera 20 receives the image capture start request, acquires image information for a preset direction from a CCD camera 30, adds the identification number of the wireless image capturing device 2A and the location information calculated by the GPS terminal, and transmits the result to the server 1 (step S4).

When the image information that has attached the identification number and the location information of the wireless image capturing device 2A has been received by the server 1, it is displayed on a predetermined portion of the screen (not illustrated) (step S4). At the disaster response center where the server 1 is disposed, it is confirmed whether or not the image capture direction coincides the direction of the desired object (step S5).

In the case that the image capture direction does not match that of the desired object (step S5, NO), at the disaster response center an instruction for the image capture direction is input (step S6). The server 1 receives the input of the image capture direction instruction, and transmits an image capture direction change request to the IP camera 20.

When the IP camera 20 receives the image capture direction change request, it rotates in the instructed image capture direction (step S7), again acquires the image information in the instructed image capture direction, and transmits the image information that has attached the identification number and the location information of the wireless image capturing device 2A to the server 1 (step S4).

In the case that the desired object is in the image capture direction (step S5, YES), this image capture direction decision is input in the server 1 at the disaster response center (step S8). The server 1 receives the input of the image capture direction decision, and transmits an image capture start request to the IP camera 20.

Based on the image capture start request, the IP camera 20 starts streaming the image information acquired from the CCD camera 20 (step S9).

Specifically, the IP camera 20 acquires the image information for the instructed image capture direction, attaches the identification number and location information of the wireless image capturing device 2A, and transmits the result to the server 1 (step S10).

When the reception of the image information has started (step S11), the server 1 writes the information into the image information DB4 triggered by the input of a predetermined interval (for example, each time a constant time interval passes) or of the image capture stop (including temporary stop) request. At this time, the server 1 refers to the relevant facility information from the facility information DB3 using the location information that has been attached to the image information as a key (step S12), and if there is facility information corresponding to this location information, these are associated and the image information is written into the image information DB4 (step S13).

Therefore, according to the wireless camera network system of the present embodiment, an effect is attained that image information can be stably acquired even at locations that cannot be completely covered by a fixed-line camera network system. In addition, the effect is attained that the association between location information and the image information is easily made, and at the same time, during a disaster, for example, necessary information (specification of the disaster location, images showing the extent of the disaster) can be provided simultaneously because the location information is acquired depending on the site location and is managed in a database along with the image information.

In addition, according to the wireless image capturing device of the present embodiment, the effect is attained that because a plurality of power input units are available, continuous usage becomes possible while switching alternately between the plurality of power sources (batteries) mounted on vehicles from various power input units when a plurality of vehicles have arrived to the site, for example, during the initial stages of a disaster.

In addition, as power interfaces differing from the above, for example, power can be also stably supplied even during emergencies by simultaneously connecting power generators that serve as external power sources when these power generators, which are compatible with a household power source, have reached the disaster site.

In addition, by providing in plurality differing power input/output interfaces, the effect is attained that during emergencies the risk of not being able to supply power quickly is reduced even for a short period of time.

Note that in the present embodiment, the case was explained wherein the facility information management DB 3 stores in advance the facility information associated with predetermined location information. However, the present invention is not limited thereby, The identification information and facility information for the predetermined wireless image capturing devices 2A to 2C can be stored after being associated in advance.

In this case, the effect is attained that even in the case that the location information for the wireless image capturing devices 2A to 2C cannot be obtained, database management of the locations captured in the received image information can be carried out based on the location information associated with the facility information.

In addition, in the present embodiment, an example of the case in which the IP camera 20 provides image information to a server 1 was presented. However, the present invention is not limited thereby. For example, a secondary memory device can be provided in the wireless image capturing device to store the image information.

By being structured in this manner, the effect is attained that the wireless image capturing device can act as a file server and publish the stored image information on a network.

In addition, where the wireless image capturing devices act as a server, the effect is attained that, even in comparison, for example, to a mobile telephone terminal having an image capturing function, a LAN can be freely constructed between a plurality of wireless image capturing devices,

The server 1 and the wireless image capturing devices 2A to 2C described above have an internal computer system.

In addition, the processing described above can be carried out by storing the sequence of processing steps related to the database management of the image information and the image capturing/data communication processing described above on a computer readable recording medium in a program format, and a computer reading and executing this program.

Specifically, each of the processing devices and processing units in the server 1 and the wireless image capturing devices 2A to 2C can be realized by a central arithmetic processing device such as a CPU reading this program in a main memory device such as ROM and RAM, and executing the information and arithmetic processing.

Here, a computer readable recording medium denotes, for example, a magnetic disk, a magneto-optical disk, a CD-ROM, a DVD-ROM, or semiconductor memory. In addition, this computer program can be delivered to the computer by a telecommunication line and the computer can execute the received program.

As has been explained above, in the present invention, in a wireless image capturing device, an image capturing unit captures images while inputting power from a plurality of external power source devices that supply drive power to the image capturing unit and the transmitter-receiver unit from a plurality of power input units, the transmitter-receiver unit transmits the images via a wireless telecommunication network, and a server that is connected to the wireless image capturing unit via the wireless telecommunication network receives the images. Thereby, the effect can be attained wherein image monitoring can be stably carried out over a long period of time outdoors.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description and is only limited by the scope of the appended claims.

What is claimed is:

1. A wireless camera network system comprising:
at least one wireless image capturing device having an image capturing device that captures images, a transmission device that transmits the images captured by the image capturing device via a wireless telecommunication network, and a plurality of power input devices that receive power from a plurality of external power devices for the image capturing device and the transmission device; and
a server connected to the wireless image capturing device via the wireless telecommunication network, for receiving images transmitted by the wireless image capturing device.

2. A wireless camera network system according to claim 1, wherein the server associates the received images with the wireless image capturing device to write into a predetermined memory device.

3. A wireless camera network system according to claim 1, wherein:
the wireless image capturing device has a location information acquisition device that acquires location information having latitude and longitude information for an imaged location by communicating with a GPS satellite;
the transmission device transmits the location information acquired by the image information acquisition device via the wireless telecommunication network; and
the server receives the location information from the wireless image capturing device, and associates the received image with the received location information to write into a predetermined memory device.

4. A wireless camera network system according to claim 2, wherein:
the memory device stores facility information associated with at least one predetermined wireless image capturing device or with predetermined location information; and
the server associates the received image with at least one wireless image capturing device or the location information, and further associates the facility information to write into the memory device.

5. A wireless image capturing device comprising:
an image capturing device for capturing images;
a transmission device for transmitting images captured by the image capturing device via a wireless telecommunication network; and
a plurality of power input devices for inputting power from a plurality of external power devices that supply the power for the image capturing device and the transmission device.

6. A wireless image capturing device according to claim 5, wherein the plurality of power input devices comprise power interfaces for different input voltages, respectively.

7. A wireless image capturing device according to claim 6, wherein the plurality of power input devices comprise power interfaces for different input voltages and power interfaces for a plurality of identical input voltages.
